(19) United States
(12) Patent Application Publication
(10) Pub. No.: US 2011/0169545 A1
(43) Pub. Date: Jul. 14, 2011

(54) LOW PHASE NOISE RF SIGNAL GENERATING SYSTEM AND METHOD FOR CALIBRATING PHASE NOISE MEASUREMENT SYSTEMS USING SAME

(76) Inventors: Shahen Minassian, Dix Hills, NY (US); Eli Levi, Dix Hills, NY (US)

(21) Appl. No.: 12/687,283

(22) Filed: Jan. 14, 2010

(51) Int. Cl. G06G 7/16

(52) U.S. Cl. 327/356; 331/158; 331/56

(57) ABSTRACT

Very low phase noise radio frequency (RF) source having multiple discrete frequency outputs used, for example, to calibrate phase noise measurement systems. The calibrator output frequencies can be tailored for a particular application using a scalable architecture.

### FIELD OF THE INVENTION

The present invention relates generally to the field of automatic test systems within the radio frequency (RF) field and more particularly, to automatic test equipment for sourcing very low phase noise RF signals for use in, for example, calibrating phase noise measurement systems. As such, an enhanced phase noise calibrator in accordance with the invention can include an RF signal generating system that is used as an RF source to calibrate the performance of phase noise measurement equipment and systems.

The present invention also relates to a method for calibrating a phase noise measurement system using a novel RF signal generating system.

### BACKGROUND OF THE INVENTION

Phase noise in RF systems is often the result of short term deterministic and random frequency fluctuations about a nominal carrier frequency. These fluctuations typically have a duration of less than a few seconds and are usually represented and viewed in the frequency domain. As the performance of phase noise measurement systems improves towards the thermal noise floor dictated by kTB noise, or −174 dBm/Hz, there is a urgent need for corresponding RF sources with lower phase noise to calibrate these systems.

### SUMMARY OF THE INVENTION

An RF signal generating system that can generate RF signals for use in calibrating phase noise measurement equipment and systems in accordance with the invention includes a plurality of medium to high power, very low phase noise crystal oscillators that is configured with various stages of multiplication, amplification and filtering to provide the basis for a multiplexed arrangement of frequencies which can then be heterodyned using a frequency mixer to produce a desired range of frequencies. The upconverted (or downconverted) output may then be amplified to maintain sufficient drive level to avoid thermal noise contributions. The amplified signal may then be filtered to isolate the desired product(s) from the frequency mixer output. The filtered upconverted output may be used directly or processed further to extend the range of frequency outputs.

### BRIEF DESCRIPTION OF THE DRAWINGS

The following drawings are illustrative embodiments of the invention and are not meant to limit the scope of the invention as encompassed by the claims.

FIG. 1 shows a simplified overall block diagram of a main conversion stage of an RF signal generating system for an enhanced phase noise calibration system in accordance with the invention.

FIG. 2 shows an optional stage to follow the main conversion stage to multiplex additional filtering or additional stages of multiplication/amplification/filtering to generate additional low phase noise frequency outputs in the band(s) of interest.

### DETAILED DESCRIPTION OF PREFERRED EMBODIMENTS

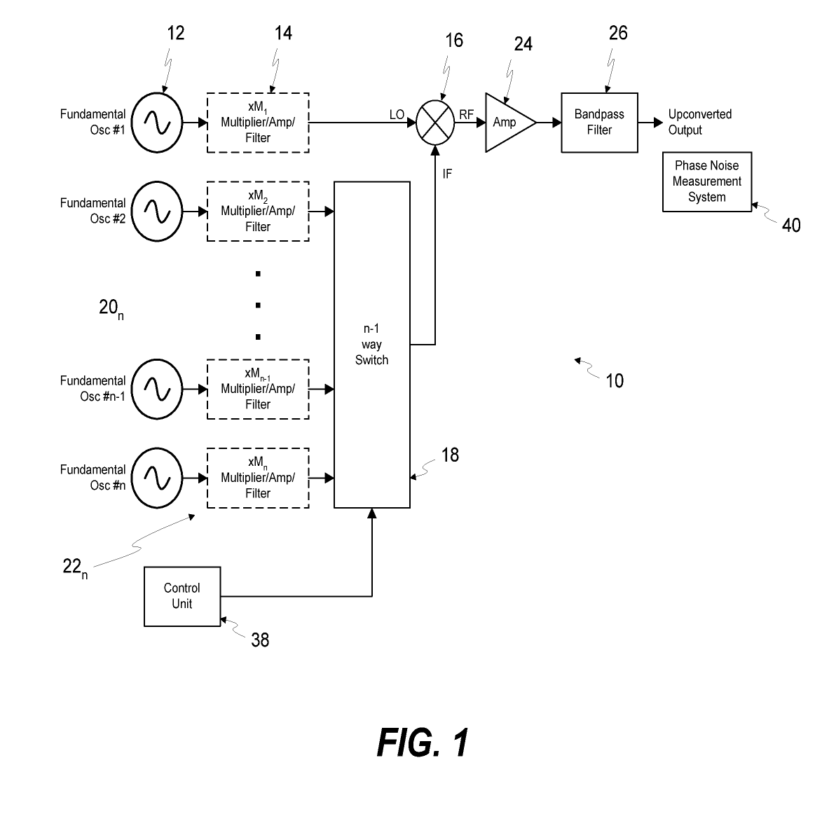

Referring to the accompanying drawings wherein like reference numerals refer to the same or similar elements, FIG. 1 shows an embodiment of an RF signal generating system for use in a system and method for calibrating a phase noise measurement system in accordance with the invention. The RF signal generating system is designated generally as 10 and includes a main crystal oscillator 12 with very low phase noise whose output signal is routed through a multiplier chain 14 consisting of a multiplier with integer multiplication factor M₁, which is then amplified via an amplifier or comparable structure, filtered via a filter or comparable structure, and routed to a frequency mixer 16. This signal will serve as a local oscillator (LO) input to the frequency mixer 16 and is utilized in generating all subsequent output frequencies. Since this chain 14 will be common to all frequencies, some form of mechanical frequency adjustment and/or electrical frequency control may be included to allow for nominal adjustment of the frequencies produced.

In an alternate embodiment, not shown, a multiplexed plurality of oscillators, either operating at their fundamental frequency or an integer multiple thereof is used to source the LO port of the frequency mixer 16 to allow a greater range of discrete frequencies to be generated. Thus, oscillator 12 represents one of one or more such oscillators while multiplier chain 14 represents one of one or more such multiplier chains.

The intermediate frequency (IF) port of the frequency mixer 16 may be sourced from a multi-pole switch, i.e., n−1 way switch 18, that allows a plurality of frequencies to be applied to the frequency mixer 16. The signals applied at the inputs of the multi-pole switch 18 can each be sourced directly from a very low phase noise crystal oscillator 20ₙ or optionally routed through a respective multiplication stage or multiplier chain 22ₙ, each consisting of a multiplier with integer multiplication factor Mₙ, which is then amplified via an amplifier or comparable structure, and filtered via a filter or comparable structure. The integer multiplication, in the form of a doubler, tripler, quadrupler, etc., may be applied to one or more of the multiplexed very low phase noise crystal oscillators 20ₙ.

The range and number of output frequencies produced at the RF output port of the frequency mixer 16 can be tailored to any specific application by selecting, via a control unit 38 coupled to the multi-pole switch 18, the number of fundamental oscillators 20ₙ providing signals to the multi-pole switch 18, appropriate fundamental oscillator frequencies, and multiplication factors used in the multiplier chains 22ₙ in conjunction with each fundamental oscillator 20ₙ. The multiplication factor used with each fundamental oscillator 20ₙ need not be the same as the prior or subsequent stage. Higher multiplication factors may require the use of one or more cascaded stages of multiplication to achieve the desired multiplication factor.

The system thus enables implementation of a fundamental main oscillator 12 in conjunction with a mixing/amplifying/filtering stage, via multiplier chain 14, and a multiplexed bank of fundamental oscillators 20ₙ to produce a selectable plurality of discrete low phase noise frequency outputs.

The output from the RF port of the frequency mixer 16 may then be directed to an amplifier 24 and then to a bandpass filter 26 to provide upconverted output for use in calibration a phase noise measurement system 40. Additional and alternative uses of the output from the RF port of the frequency mixer 16 are also envisioned. Depending on the range of frequencies involved for an application, an alternate embodiment, not shown, may utilize a multiplexed bank of amplifiers and/or bandpass filters to handle the range of resulting very low phase noise RF mixer output frequencies. Thus, amplifier 24 and bandpass filter 26 each represent one of one or more such amplifiers and bandpass filters.

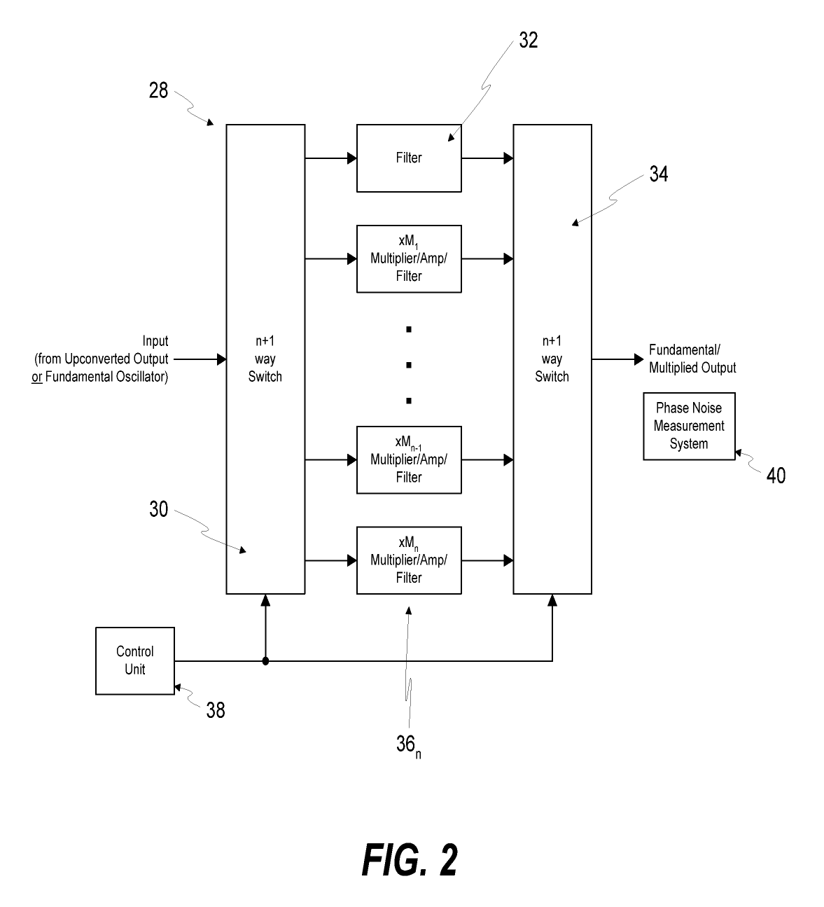

Referring now to FIG. 2, the upconverted output from filter 26 may be routed through another multiplexed stage 28 of signal filtering and/or multiplication. In this stage 28, the range of input frequencies output from the filter 26 are applied to a multi-pole switch, i.e., n+1 way switch 30. This stage 28 includes a bypass path in which the input to switch 30 is filtered further via a filter 32 and fed into another multi-pole switch, i.e., n+1 way switch 34, before arriving at the common output, which may be directed to the phase noise measurement system 40. There is no multiplication or amplification of the signal passing through the bypass path.

Stage 28 also includes one or more multiplication stages 36ₙ, each multiplication stage 36ₙ consisting of an integer multiplier (doubler, tripler, etc.), amplifier and bandpass filter, so that the multiplication stages 36ₙ allow the range of very low phase noise frequencies to be extended to higher frequencies. Additional stages could be added as well, although each stage of conventional integer multiplication adds 20 log(M) dB of phase noise relative to its input so there are practical limitations to how extensible the architecture can be.

It is envisioned that stage 28 may be used in lieu of the first stage shown in FIG. 1 as an alternate means of providing multiple very low phase noise signal sources. That is, the fundamental oscillator 12 may be coupled to the switch 30, without the interposition of the multiplier chain 14, frequency mixer 16, amplifier 24 and bandpass filter 26, and provide its output signal directly to the switch 30.

Control of the switching of switches 18, 30, 34 can be handled in various ways. In one embodiment, an embedded microprocessor or microcontroller serves as the control unit 38 and would be used to select the appropriate switch position(s) based on the desired output frequency. Other constructions of a control unit for controlling switches readily present themselves to one of ordinary skill in the art to which this invention pertains in view of the disclosure herein and are contemplated to be within the scope and spirit of the invention.

Power saving measures could be implemented to power down multiplication stages not in use. Control could be further extended to include built-in-test (BIT) units and programs, power monitoring units and programs, etc.

At the L-Band frequencies involved, the following single sideband (SSB) phase noise ranges can be met (all of the upper and lower limits of the ranges are approximate values):

100 Hz carrier offset: −105 to −110 dBc/Hz
1 kHz carrier offset: −135 to −140 dBc/Hz
10 kHz carrier offset: −150 to −155 dBc/Hz
100 kHz carrier offset: −155 to −160 dBc/Hz
500 kHz carrier offset: −159 to −164 dBc/Hz
≧1 MHz carrier offset: −159 to −164 dBc/Hz

These values represent the currently achievable SSB phase noise specifications using this approach and are not meant to limit the scope of the invention as improved crystal oscillators and/or multiplication circuits may allow for performance improvements in the future.

The RF signal generating system for use in an enhanced phase noise calibrator described above is designed to source multiple output signals in the L-Band and S-Band range of frequencies, but the output frequency should not limit the scope of the invention as it may be adapted to other frequency bands. Control of the RF signal generating system for the enhanced phase noise calibrator may be through an IEEE-488 bus but the method of control should not limit the scope of the invention as it may be adapted to other parallel control means (MXI, etc.), serial (LXI, USB, RS-485, etc.), RF (Bluetooth, Wi-Fi, Zigbee, UWB, etc.) or optical (IR, fiber-optic, etc.) control buses or via discrete control.

Power for the RF signal generating system for the enhanced phase noise calibrator may be provided by linear analog power supplies, rather than switching power supplies, to limit introduction of other potential sources of phase noise which could be introduced in the form of spurious or harmonic signals relating to power line frequencies, switching frequencies, electromagnetic interference (EMI) or other undesirable contributions. Ideally, operation would be from a direct current (DC) source such as a battery, but for the operating environment in which it would be used, a DC source does not provide the most practical approach.

In the embodiments described above, the oscillators are described as being crystal oscillators. However, other types of low phase noise oscillators may be used in the invention without deviating from the scope and spirit thereof.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention. Indeed, it is envisioned that any feature shown in or described in connection with one embodiment may be applied to any of the other embodiments shown or described herein to the extent not inconsistent with a particular feature of that embodiment.

1. A system for generating a very low phase noise signal, comprising:
at least one main oscillator providing an output signal;
at least one multiplier chain that receives the output signal from a respective one of said at least one main oscillator, each of said at least one multiplier chain including a multiplier that multiplies the signal frequency by integer multiplication factor M₁, an amplifier that amplifies the multiplied signal and a filter that filters the amplified signal;
a frequency mixer having a local oscillator (LO) input, an intermediate frequency (IF) input and a radio frequency (RF) output, said at least one multiplier chain providing an output signal that is input from said at least one multiplier chain to said LO input of said frequency mixer;
a plurality of additional oscillators each providing output signal;
a first, multi-pole switch coupled to said additional oscillators and said IF input of said frequency mixer and arranged to provide an output signal derived from a signal from at least one of said additional oscillators to said IF input of said frequency mixer;
a plurality of additional multiplier chains,
each of said additional multiplier chains continuously receiving an output signal from a respective one of said additional oscillators, modifying the output signal and providing the modified output signal to said first switch,
each of said additional multiplier chains including a multiplier that multiplies the signal frequency of the output signal of said respective additional oscillator by an integer multiplication factor, an amplifier that amplifies the multiplied signal and a filter that filters the amplified signal, the filtered, amplified signal being directed to said first switch and then through said first switch to said IF input of said frequency mixer; and
a control unit coupled to said first switch and that, by controlling said switch, selects a number of said additional oscillators and thus a frequency output from said first switch to said IF input of said frequency mixer to enable variation of a range and number of output frequencies at said RF output of said frequency mixer,
whereby all input signals to said frequency mixer are signals generated by one of said at least one main oscillator or one of said additional oscillators and which have passed through said at least one multiplier chain or one of said additional multiplier chains; and
whereby the output signal from said at least one multiplier chain is not directed to or through said first switch such that said frequency mixer receives output signals at said LO input continuously from said at least one main oscillator that have been directed into and through said at least one multiplier chain and also receives output signals at said IF input from said additional oscillators via said first switch, and
whereby the signal from said RF output of said frequency mixer is directed to at least one amplifier and at least one bandpass filter to provide upconverted output.

2. The system of claim 1, wherein said at least one main oscillator and said additional oscillators are crystal oscillators with very low phase noise.

3. (canceled)

4. The system of claim 1, wherein said additional multiplier chains are equal in number to said plurality of additional oscillators, said multiplier of each of said additional multiplier chains being different than said multiplier of other of said additional multiplier chains.

5. The system of claim 1, wherein said control unit is further arranged to select the multiplication factor of each of said additional multiplier chains.

6. The system of claim 1, further comprising:
a second switch arranged to receive the output from said at least one bandpass filter;
at least one multiplication stage following said second switch; and
a third switch following said at least one multiplication stage, each of said at least one multiplication stage including a multiplier that multiplies the signal frequency by an integer multiplication factor, an amplifier that amplifies the multiplied signal and a filter that filters the amplified signal.

7. The system of claim 6, further comprising a bypass path between said second and third switches including only a filter.

8. The system of claim 6, wherein said control unit is arranged to control said second and third switches to select a multiplication stage based on a frequency of a desired output signal.

9. An automatic test equipment for calibrating phase noise measurement systems including the system of claim 1.

10-13. (canceled)

14. A method for calibrating a phase noise measurement system, the method comprising:
generating a very low phase noise signal by means of an RF signal generating system including:
at least one main oscillator,
a frequency mixer having a local oscillator (LO) input, an intermediate frequency (IF) input and a radio frequency (RF) output,
at least one multiplier chain interposed between the at least one main oscillator and the LO input of the frequency mixer such that an output signal from the at least one multiplier chain is input from the at least one multiplier chain to the LO input of the frequency mixer, and each of the at least one multiplier chain including a multiplier that multiplies the signal frequency by integer multiplication factor M₁, an amplifier that amplifies the multiplied signal and a filter that filters the amplified signal;
a plurality of additional oscillators each providing output signal; and
a first, multi-pole switch coupled to the additional oscillators and the IF input of the frequency mixer, the first switch being arranged to provide an output signal derived from a signal from at least one of the additional oscillators to the IF input of the frequency mixer;
arranging a plurality of additional multiplier chains between the additional oscillators and the first switch, each of the additional multiplier chains being arranged to continuously receive an output signal from a respective one of the additional oscillators, modify the output signal and provide the modified output signal to the first switch, each of the additional multiplier chain including a multiplier that multiplies the signal frequency of the respective additional oscillator by an integer multiplication factor, an amplifier that amplifies the multiplied signal and a filter that filters the amplified signal;
directing the filtered, amplified signal from each additional multiplier chain to the first switch; and
controlling the first switch, via a control unit coupled to the first switch, to cause at least one of the filtered, amplified signals from one of the additional multiplier chains to be passed through the first switch to the IF input of the frequency mixer to thereby control a frequency of the output from the first switch to the IF input of the frequency mixer to vary a range and number of output frequencies at the RF output of the frequency mixer; and
directing the signal output from the frequency mixer toward the phase noise measurement system,
whereby all input signals to the frequency mixer are signals generated by one of the at least one main oscillator or one of the additional oscillators and which have passed through the at least one multiplier chain or one of the additional multiplier chains; and
whereby the output signal from the at least one multiplier chain is not directed to or through the first switch such that the frequency mixer receives output signals at the LO input continuously from the at least one main oscillator that have been directed into and through the at least one multiplier chain and also receives output signals at the IF input from the additional oscillators via the first switch,
whereby the signal from said RF output of said frequency mixer is directed to at least one amplifier and at least one bandpass filter to provide upconverted output.

15. The method of claim 14, wherein the step of directing the signal output from the frequency mixer toward the phase noise measurement system comprises directing the signal output from the frequency mixer to at least one amplifier and at least one bandpass filter to provide upconverted output.

16. The method of claim 14, further comprising selecting frequencies of the oscillators to provide output frequencies in the L-Band or S-Band range.

17. (canceled)

18. (canceled)

19. The method of claim 14, wherein the step of directing the signal output from the frequency mixer toward the phase noise measurement system comprises directing the signal through a second switch, at least one multiplication stage following the second switch and a third switch following the at least one multiplication stage, each of the at least one multiplication stage including a multiplier that multiplies the signal frequency by an integer multiplication factor, an amplifier that amplifies the multiplied signal and a filter that filters the amplified signal.

20. The method of claim 19, further comprising selecting one of the at least one multiplication stage between the second and third switches based on a frequency of a desired calibration signal for the phase noise measurement system.

21. The system of claim 4, wherein said control unit is further arranged to select the multiplication factor of said multiplier of each of said additional multiplier chains to be different such that said control unit is able to control said first switch to select a particular multiplied frequency for output to said IF input of said frequency mixer.

22. The system of claim 1, wherein said at least one main oscillator consists of a single main oscillator whose output signals is thus used in generating all output frequencies from said frequency mixer.

23. The system of claim 22, wherein said at least one multiplier chain consists of a single multiplier chain interposed between said single main oscillator and said LO input of said frequency mixer such that said single multiplier chain is common to all frequencies.

24. The system of claim 1, wherein said first switch is the only switch between said additional oscillators and said frequency mixer.

25. The system of claim 1, wherein said first switch is a first switch in a signal path from said additional oscillators such that output signals from said additional oscillators do not pass through another switch before said first switch.

26. The method of claim 14, wherein the control unit is arranged to select the multiplication factor of the multiplier of each of the additional multiplier chains to be different such that the control unit controls the first switch to select a particular multiplied frequency for output to the IF input of the frequency mixer.

27. The method of claim 14, wherein the at least one main oscillator consists of a single main oscillator whose output signals is thus used in generating all output frequencies from the frequency mixer.
